(19) United States
(12) Patent Application Publication
(10) Pub. No.: US 2015/0375659 A1
(43) Pub. Date: Dec. 31, 2015

(54) Fast Food Carrier

(71) Applicant: Sonoco Development, Inc., Hartsville, SC (US)

(72) Inventors: Victoria Noble, Florence, SC (US); Paula Costantini, Hartsville, SC (US); Sarah Kinsey, Hartsville, SC (US)

(21) Appl. No.: 14/318,942

(22) Filed: Jun. 30, 2014

(51) Int. Cl. B60N 3/10; B65D 71/64; B65D 5/20; A47J 47/14; B65D 5/42

(52) U.S. Cl. CPC B60N 3/103; A47J 47/14; B65D 5/4208; B65D 5/4266; B65D 5/20; B65D 71/0048

(57) ABSTRACT

A carrier for items such as fast food includes a box-like base and a handle. A bottom opening in the base may be used to hold a drink cup which is then placed within a cup holder in the user's vehicle to anchor the carrier. When the user lifts the drink cup tabs remain inside the cup holder anchoring the carrier to the cup holder. The carrier can be anchored to cup holders of varying sizes.

### BACKGROUND OF THE INVENTION

1. Field of the Invention

This disclosure relates to a carrier for items such as fast food. More particularly, this disclosure relates to a fast food carrier that can be secured to a cup holder in, for example, an automobile center console.

2. Description of the Related Art

Fast food bags have a number of disadvantages. The food can be hard to see, and wrong orders can go unnoticed until it is too late to correct. Eating food from a bag in a car can be messy, especially if the food includes catsup or a dipping sauce. Bags can fall over in a car causing the contents to spill out. Also, the consumer may waste food if it is difficult to reach in the bag.

The present disclosure is intended to address these disadvantages.

### BRIEF SUMMARY OF THE INVENTION

The present invention is a carrier for items such as fast food includes a box-like base and a handle. A bottom opening in the base may be used to hold a drink cup which is then placed within a cup holder in the user's vehicle to anchor the carrier. When the user lifts the drink cup tabs remain inside the cup holder anchoring the carrier to the cup holder. The carrier can be anchored to cup holders of varying sizes.

In one embodiment the carrier comprises a bottom panel, two side panels, two end panels and two top panels. The bottom panel has a perimeter and defines a substantially circular bottom opening for positioning over a cup holder. The bottom opening is configured to receive a drink cup and has a bottom opening perimeter. The bottom panel perimeter comprises opposing first side fold lines and opposing first end fold lines.

The two side panels extend upward from the first side fold lines. The two end panels extend upward from the first end fold lines. The bottom panel, side panels and end panels form a box-like base for holding items such as fast food.

The carrier further comprises a plurality of tabs extending inwardly from the bottom opening perimeter and configured to fold downwardly from a first position in which the tabs are co-planar with the bottom panel to a second position in which the tabs are located below a plane defined by the bottom panel.

A top panel extends upwardly from each end panel, the top panels meeting in flat, facing abutment to form a handle.

### BRIEF DESCRIPTION OF THE DRAWINGS

FIG. 1 is a perspective view of a carrier for holding items such as fast food according to the disclosure.

FIG. 2 is a plan view of a blank that can be used to make the carrier of FIG. 1.

FIG. 3 is a perspective view of a second embodiment of a carrier for holding items such as fast food.

FIG. 4 is a plan view of a blank that can be used to make the carrier of FIG. 3.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

The invention is a fast food carrier that can be secured to a cup holder in, for example, an automobile center console. The carrier can be made from a single folded blank and shipped flat to the store where it can be quickly assembled by store personnel.

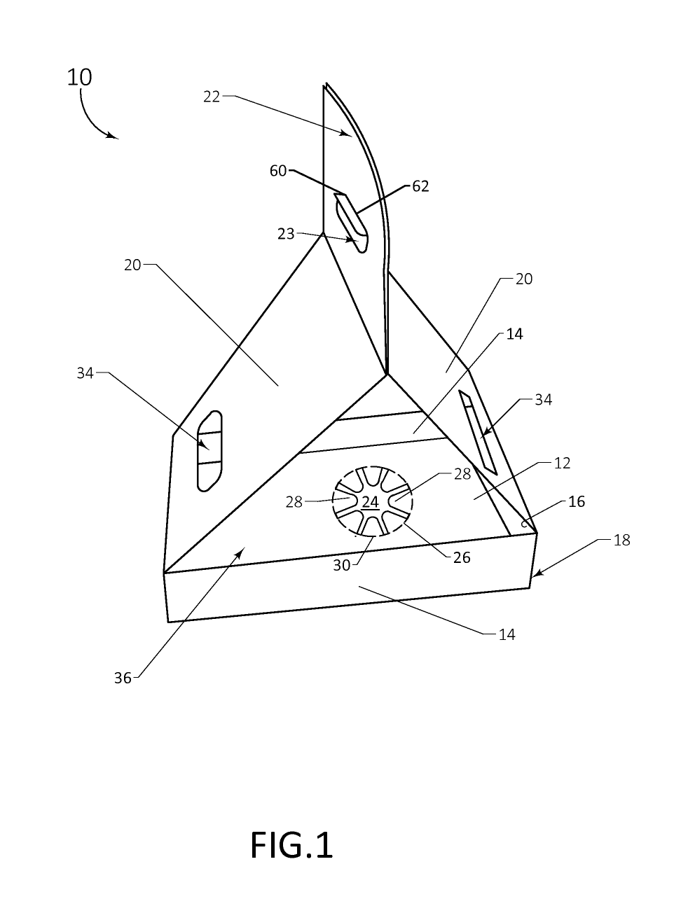

Turning to the drawings, there is shown in FIG. 1 one embodiment of the present invention, a carrier 10 for holding items such as fast food. The carrier 10 comprises a bottom panel 12, two side panels 14 and two end panels 16 extending upward from a perimeter of the bottom panel 12 to form a carrier base 18.

Top panels 20 extend upwardly from the end panels 16 and come together (meet in flat, facing abutment) to form a handle 22. The handle 20 may define a handle opening 23 to facilitate carrying the carrier 10. Once the carrier 10 is properly positioned and the consumer is ready to eat, the top panels 20 can be folded outwardly to expose the food for easier access.

The bottom panel 12 may be rectangular. The bottom panel 12 may define a bottom opening 24. The bottom opening 24 may be substantially circular or any suitable shape. In the illustrated embodiment the bottom opening 24 is circular and has a circular perimeter 26 having a diameter D.

A plurality of tabs 28 may extend inwardly from the bottom opening perimeter 26 to partially cover the bottom opening 24. Each tab 28 may have a tab base 30 and an apex 32. Each tab base 30 may be substantially coincident with, that is, lie along the same arc as, the bottom opening perimeter 26.

The tabs 28 may be folded downwardly from a first position, in which the tabs 28 are co-planar with the bottom panel 12 as shown in FIG. 1, to a second position, in which the tabs 28 are located below the plane defined by the bottom panel 12 and within a cup holder for the purpose of securing the carrier 10 to the cup holder. For example, when a drink cup is placed into the opening 24 the drink cup will push or force the tabs 28 downward so that the tabs 28 are flush against the outer surface of the drink cup. The user may then secure the carrier 10 to a vehicle cup holder located in many cars and other vehicles in a center console by placing the carrier 10 on top of the console/cup holder with the bottom of the drink cup located within the cup holder. When the user lifts the drink cup the tabs 28 stay inside the cup holder to help keep the carrier 10 secure to the cup holder and, in most cases, to the vehicle's center console.

If desired, the carrier 10 can be placed on an automobile center console with the opening 21 located over a cup holder and the tabs 22 folded downward into the cup holder to help secure and stabilize the carrier 10. The carrier 10 can be mounted over cup holders of different dimensions.

Optional sauce holder openings 34 in the top panels 24 and side gaps 36 between the top panels 20 and the carrier base 18 allow the consumer to see the food that has been purchased. Optional catsup or sauce holders (not shown) can be nested within the sauce holder openings 34.

Thus FIG. 1 shows a carrier 10 comprising a box-like base 18 and a handle 22 formed by two top panels 20. The handle 22 may be disassembled and the two top panels 20 folded back out of the way to provide access to the contents. When the top panels 20 are folded back the interior surfaces 21 of the top panels 20 provide a convenient serving platform. Optional openings 34 in the top panels 20 may hold sauce containers. Thus the carrier 10 expands the area that can hold food and serves as a cleanliness barrier for the user's vehicle.

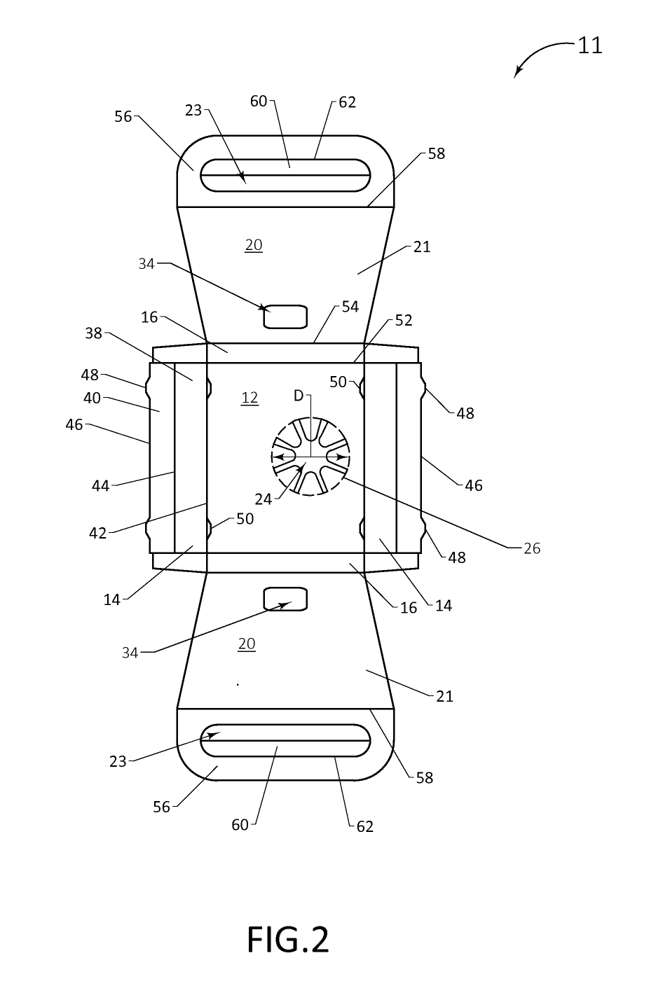

FIG. 2 is a blank 11 that can be used to make the carrier 10 shown in FIG. 1. The blank 11 can be shipped to the customer flat as shown in FIG. 2 or pre-folded and glued as shown in FIG. 1. The blank 11 comprises a bottom panel 12, two side panels 14, two end panels 16 and two top panels 20.

The bottom panel 12 may be rectangular and may define a substantially circular bottom opening 24 having a diameter D. A plurality of tabs 28 extend inwardly from the bottom opening perimeter 26 to partially cover the bottom opening 24. Each tab 28 may extend inwardly from the bottom opening perimeter 26 from the tab base 30 to the tab apex 32.

Each side panel 14 may comprise a side outer panel 38 and a side inner panel 40. The side outer panel 38 may be foldably connected to the bottom panel 12 along a first side fold line 42. Each side inner panel 40 may be connected to a corresponding side outer panel 38 along a second side fold line 44 and have a free edge 46 substantially parallel to the first and second side fold lines 42, 44. One or more locking tabs 48 may extend outward from the free edge 46 and are configured to fit within one or more corresponding slots 50 located in the bottom panel 12 adjacent the first side fold line 42.

Each end panel 16 is foldably connected to the bottom panel 12 along a first end fold line 52.

Each top panel 20 may be connected to a corresponding end panel 16 along a second end fold line 54. Each top panel 20 may comprise a handle portion 56 connected to a main top panel 57 along a handle fold line 58. Each handle portion 56 may define a handle opening 23. The handle portions 56 may cooperate in flat abutting relationship in the assembled carrier 10 and may be glued together to form the handle 22 as shown in FIG. 1. Optional flaps 60 attached to the handle portions 56 along flap fold lines 62 may be used to hold the handle portions 56 together without glue by folding the flaps 60 together so that they are both on one side or the other of the plane defined by the handle 22 in FIG. 1.

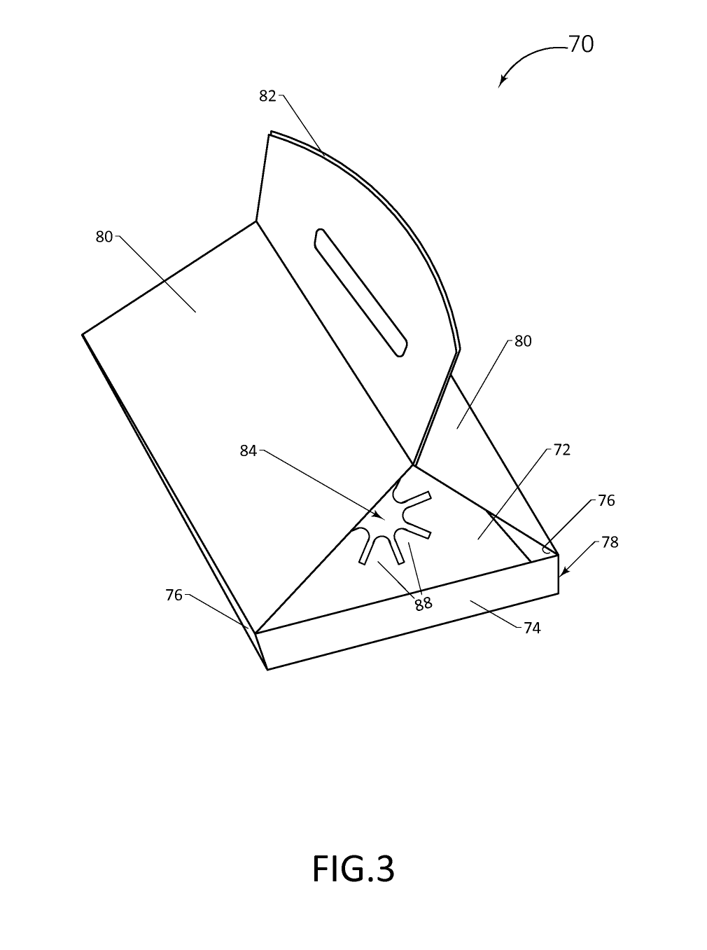

FIG. 3 is a second embodiment of the present invention, a carrier 70 for holding items such as fast food. The carrier 70 is similar to the first embodiment in that it comprises a bottom panel 72, two side panels 74 and two end panels 76 extending upward from a perimeter of the bottom panel 72 to form a carrier base 78. Top panels 80 extend upwardly from the end panels 76 and come together to form a handle 82. The bottom panel 72 defines a bottom opening 84. Tabs 88 may extend inwardly to partially cover the bottom opening 84. As in the first embodiment, the tabs 88 may be folded downwardly from a first position in which the tabs 88 are co-planar with the bottom panel 72 as shown in FIG. 3, to a second position, in which the tabs 88 are located below the plane defined by the bottom panel 72 and within a cup holder for the purpose of securing the carrier 70 to the cup holder. The second embodiment 70 lacks the sauce holder openings 34 of the first embodiment 10 but is otherwise quite similar.

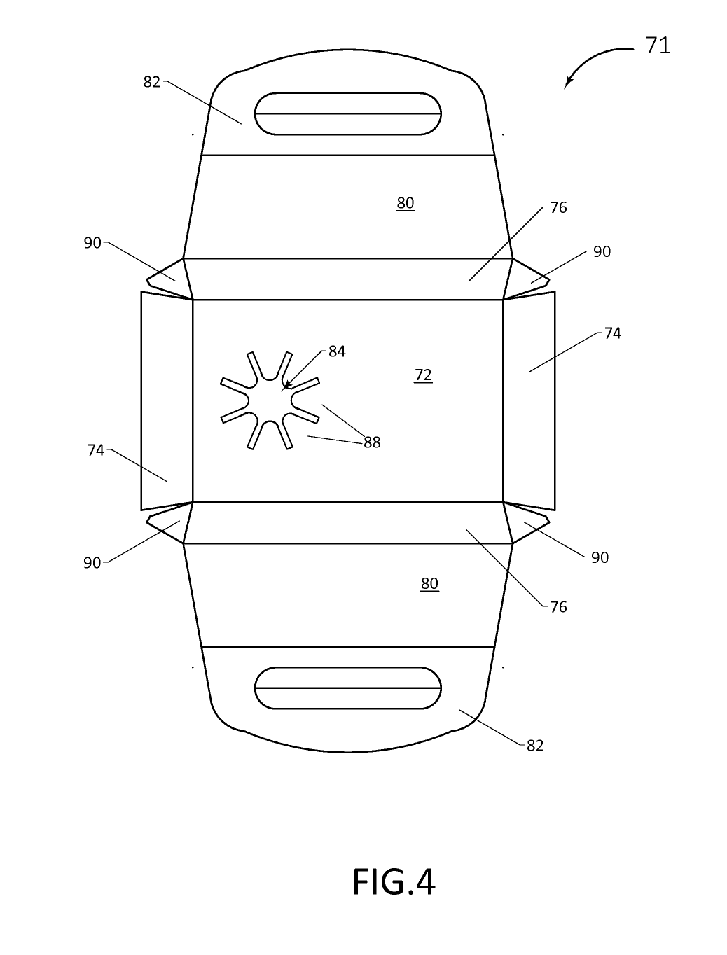

FIG. 4 is a blank 71 that can be used to make the second embodiment shown in FIG. 3. The blank 71 comprises a bottom panel 72, two side panels 74, two end panels 76 and two top panels 80. Unlike the first embodiment, the side panels 74 do not comprise a double thickness of material such as the side outer and inner panels 38, 40 of the first embodiment, not do the side panels 74 comprise locking tabs that fit within slots in the bottom panel. Instead, the side panels 74 are a single thickness and secured to the end panels 76 by glue tabs 90 as is known in the packaging field.

### APPLICATIONS

The carrier of the present disclosure can be used to hold and transport any suitable item or items, but is especially useful in carrying fast food and providing a serving platform for the fast food when consumed in a vehicle such as a car with a cup holder in the center console.

The carrier can be used to hold both food and a drink cup so that the end user does not have to carry a separate bag and drink cup. The carrier provides a more stable means for carrying a drink cup than that provided by a fast food bag.

The carrier can be made from a single folded blank and shipped flat to the store where it can be quickly assembled by store personnel. The carrier may be assembly with or without glue or other adhesive. The blank may be made of paperboard, plastic or any suitable material.

The carrier includes openings and gaps that allow a user to easily see what is in the carrier so the consumer can confirm her order before leaving the restaurant.

The carrier includes a box-like base and a handle for easy carrying. A bottom opening in the base may be used to hold a drink cup which is then placed within a cup holder in the user's vehicle to anchor the carrier. When the user lifts the drink cup the tabs remain inside the cup holder, anchoring the carrier to the cup holder. The carrier can be anchored to cup holders of varying sizes.

The handle may be disassembled and the two handle portions folded back out of the way to provide access to the contents. When the handle portions are folded back the carrier provides a convenient flat horizontal serving platform, including optional openings in the handle portions to hold sauce containers. Thus the carrier expands the area that can hold food and serves as a cleanliness barrier for the car.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A carrier made from a single folded blank, the carrier comprising:
a bottom panel having a perimeter and defining a substantially circular bottom opening for positioning over a cup holder, the bottom opening configured to receive a drink cup and having a bottom opening perimeter, the bottom panel perimeter comprising opposing first side fold lines and opposing first end fold lines, the bottom panel further defining one or more slots located in the bottom panel adjacent and contiguous with the first side fold lines;
two side panels extending upward from the first side fold lines, each side panel comprising a side outer panel and a side inner panel, the side outer panel foldably connected to the bottom panel along the first side fold line and extending upward, the side inner panel foldably connected to a side outer panel along a second side fold line and extending downward, each inner side panel comprising one or more locking tabs extending through one of the slots defined by the bottom panel in a downward direction, perpendicular to the bottom panel;
two end panels extending upward from the first end fold lines;
the bottom panel, side panels and end panels forming a box-like base for holding items;
a plurality of tabs extending inwardly from the bottom opening perimeter and configured to fold downwardly from a first position in which the tabs are co-planar with the bottom panel to a second position in which the tabs are located below a plane defined by the bottom panel; and
a top panel extending upward from each end panel, the top panels meeting in flat, facing abutment to form a handle, at least one of the top panels defining a sauce holder opening for receiving a sauce holder.

2. The food carrier of claim 1 wherein:
each top panel comprises a main top panel connected to an end panel along a second end fold line and a handle portion connected to the main top panel along a handle fold line, each handle portion defining a handle opening, the handle portions cooperating in flat abutting relationship to form the handle.

3. The food carrier of claim 2 further comprising:
a flap attached to each handle portion along a flap fold line, the flaps configured to hold the handle portions together when the flaps are located on one side of a plane defined by the handle.

4. The food carrier of claim 3 wherein:
each top panel has an interior surface that, when the top panels are folded outwardly to expose the items, provides a serving platform.

5. (canceled)

6. (canceled)

7. A blank for forming a fast food carrier, the blank comprising:
a rectangular bottom panel defining a substantially circular bottom opening having a perimeter and configured to receive a drink cup, the bottom panel further defining one or more slots located in the bottom panel adjacent and contiguous with a first side fold line;
a plurality of tabs extending inwardly from the bottom opening perimeter, each tab foldably connected to the bottom panel along a tab base coincident with the bottom opening perimeter;
two side panels, each side panel comprising a side outer panel and a side inner panel, the side outer panel foldably connected to the bottom panel along the first side fold line, the side inner panel foldably connected to a side outer panel along a second side fold line, each side inner panel having a free edge substantially parallel to the first and second side fold lines each side panel further comprising one or more locking tabs extending outward from the free edge and configured to fit within the one or more corresponding slots defined by the bottom panel;
two end panels, each end panel foldably connected to the bottom panel along a first end fold line;
two top panels, each top panel connected to an end panel along a second end fold line; two handle portions, each handle portion connected to a top panel along a handle fold line, each handle portion defining an elongated handle opening having a length; and
flaps attached to the handle portions along flap fold lines and extending the length of the handle opening.

8. The blank of claim 7 wherein:
at least one of the top panels defines a sauce holder opening.
